(19) United States
(12) Patent Application Publication
(10) Pub. No.: US 2019/0179561 A1
(43) Pub. Date: Jun. 13, 2019

(54) DATA STORAGE DEVICE, OPERATING METHOD THEREOF, AND STORAGE SYSTEM HAVING THE SAME

(71) Applicant: SK hynix Inc., Gyeonggi-do (KR)

(72) Inventor: Jeen PARK, Gyeonggi-do (KR)

(21) Appl. No.: 15/946,236

(22) Filed: Apr. 5, 2018

(30) Foreign Application Priority Data
Dec. 11, 2017 (KR) 10-2017-0169145

(51) Int. Cl. G06F 3/06; G06F 9/30

(52) U.S. Cl. CPC G06F 3/0652; G06F 9/3004; G06F 3/0679; G06F 3/0619; G06F 3/0653; G06F 9/30098

(57) ABSTRACT

A data storage device may include: a nonvolatile memory device; and a controller including a register, and suitable for extracting an instruction from an working memory according to a preset sequence so as to control the nonvolatile memory device, analyzing and processing the instruction, and storing a result of the processing, and suitable for storing, when a low-voltage detection event occurs, an address of an instruction that is being performed, to a preset data retention space as return instruction information and then performing a reset operation.

### CROSS-REFERENCES TO RELATED APPLICATION

The present application claims priority under 35 U.S.C. § 119(a) to Korean application number 10-2017-0169145, filed on Dec. 11, 2017, which is incorporated herein by reference in its entirety.

### BACKGROUND

### 1. Technical Field

Various embodiments generally relate to a semiconductor integrated device. Particularly, the embodiments relate to a data storage device, an operating method thereof, and a storage system having the data storage device.

### 2. Related Art

Semiconductor devices such as memory devices are being developed to have high integration, high capacity, and high performance, with a further increase in operating speed thereof.

On the other hand, the level of operating voltage for driving the semiconductor device is being gradually reduced.

The semiconductor device that operates with a low operating voltage is advantageous in terms of power consumption. Because a reduction in power consumption is a major issue in a mobile electronic device using limited power, there is a growing need to reduce the operating voltage of the semiconductor device.

The semiconductor device using a low-level operating voltage has characteristics that are sensitive to a change in level of a voltage signal provided from an external device. For example, the data transmitting speed varies depending on a change in level of an external voltage provided to a memory device, and when the rate of variation of the data transmitting speed is relatively high, an external controller may be less likely to effectively receive data.

Therefore, the semiconductor integrated device can be designed to detect and properly respond when the supply voltage falls below a minimum allowable voltage level to ensure stable and reliable operation.

### SUMMARY

In an embodiment, a data storage device may include: a nonvolatile memory device; and a controller including a register, and suitable for extracting an instruction from an working memory according to a preset sequence so as to control the nonvolatile memory device, analyzing and processing the instruction, and storing a result of the processing, and suitable for storing, when a low-voltage detection event occurs, an address of an instruction that is being performed, to a preset data retention space as return instruction information, and then performing a reset operation.

In an embodiment, a data storage device may include: a nonvolatile memory device; and a controller suitable for controlling data exchange for the nonvolatile memory device. The controller may include: a register; an working memory in which a program code is stored; a control unit suitable for extracting an instruction from the working memory according to a preset sequence, and processing the instruction; and a low-voltage detection processor suitable for storing, when a low-voltage detection event occurs, an address of an instruction that is being performed, to a preset data retention space as return instruction information, and then requesting a reset to the control unit.

In an embodiment, an operating method of a data storage device including a nonvolatile memory device and a controller suitable for controlling data exchange for the nonvolatile memory device may include: monitoring, by the controller, whether a low-voltage detection event occurs; extracting, by the controller, an address of an instruction that is being performed when the low-voltage detection event occurs; storing, by the controller, the extracted address of the instruction to a preset data retention space as return instruction information; and performing a reset operation by the controller.

In an embodiment, a storage system may include: a host device; and a controller including a nonvolatile memory device, and suitable for extracting an instruction from an working memory according to a preset sequence so as to control the nonvolatile memory device, analyzing and processing the instruction, and storing a result of the processing, and suitable for storing, when a low-voltage detection event occurs, an address of an instruction that is being performed, to a preset data retention space as return instruction information, and then performing a reset operation.

### BRIEF DESCRIPTION OF THE DRAWINGS

FIG. 1 is a configuration diagram illustrating a data storage device in accordance with an embodiment.

FIG. 2 is a configuration diagram illustrating a central processing unit in accordance with an embodiment.

3 is a configuration diagram illustrating an LVD processor in accordance with an embodiment.

FIG. 4 is a diagram illustrating a method of compressing an address in accordance with an embodiment.

FIG. 5 is a diagram illustrating a method of compressing an address in accordance with an embodiment.

FIG. 6 is a flowchart illustrating a method of operating a data storage device in accordance with an embodiment.

FIG. 7 is a diagram illustrating a data processing system including a solid state drive (SSD) in accordance with an embodiment.

FIG. 8 is a diagram illustrating a data processing system including a memory system in accordance with an embodiment.

FIG. 9 is a diagram illustrating a data processing system including a memory system in accordance with an embodiment.

FIG. 10 is a diagram illustrating a network system including a memory system in accordance with an embodiment.

FIG. 11 is a block diagram illustrating a nonvolatile memory device included in a memory system in accordance with an embodiment.

### DETAILED DESCRIPTION

Various embodiments of the present invention are described below in more detail with reference to the accompanying drawings. We note, however, that the present invention may be embodied in different forms and variations, and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Hereinafter, a data storage device, an operating method thereof, and a storage system having the data storage device will be described below with reference to the accompanying drawings through various examples of embodiments.

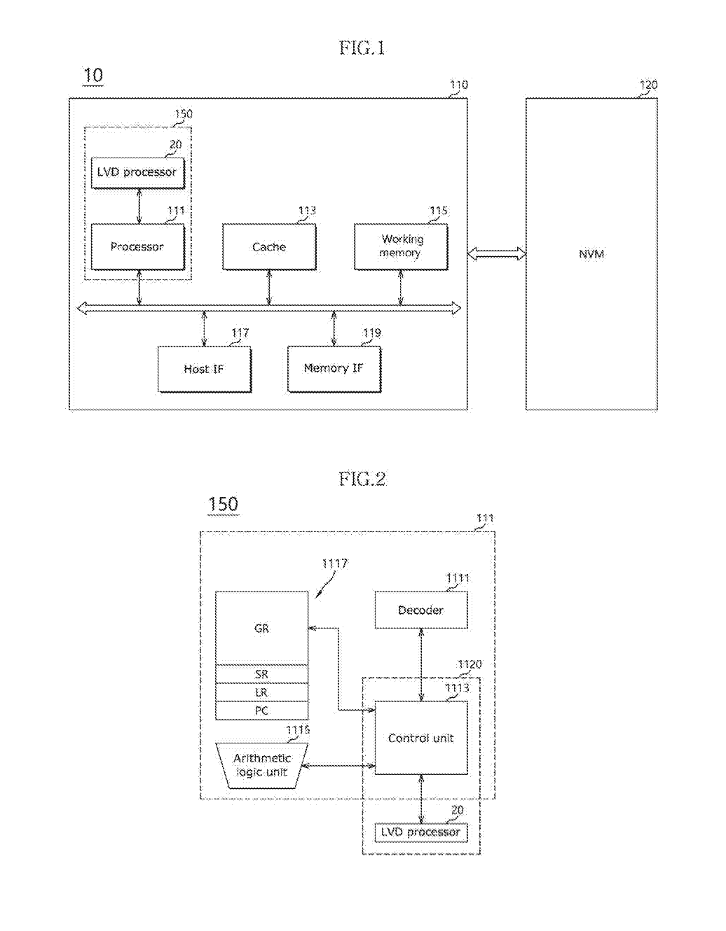

FIG. 1 is a configuration diagram illustrating a data storage device 10 in accordance with an embodiment.

Referring to FIG. 1, the data storage device 10 in accordance with the embodiment may include a controller 110 and a nonvolatile memory device (NVM) 120.

The controller 110 may control the nonvolatile memory device 120 in response to a request from a host device or a host processor. For example, the controller 110 may control the nonvolatile memory device 120 such that data provided in response to a request from the host device is programmed to the nonvolatile memory device 120. The controller 110 may provide data that is present in the nonvolatile memory device 120 to the host device in response to a read request from the host device.

The nonvolatile memory device 120 may write data or output the written data under control of the controller 110. The nonvolatile memory device 120 may be embodied using a memory device selected from among various nonvolatile memory devices such as an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-MRAM). The nonvolatile memory device 120 may include a plurality of dies, a plurality of chips, or a plurality of packages. Moreover, the nonvolatile memory device 120 may include a single-level cell capable of storing 1-bit data in each memory cell, or a multi-level cell capable of storing multi-bit data in each memory cell.

In an embodiment, the controller 110 may include a processor 111, a cache 113, a working memory 115, a host interface 117, and a memory interface 119. The controller 110 may further include a low voltage detection (LVD) processor 20.

The LVD processor 20 may be configured as a part of the processor 111 or be configured to transmit and receive signals to and from the processor 111. The LVD processor 20 and the processor 111 may be configured as parts of the central processing unit 150. In an embodiment, the processor 111 itself may be considered as the central processing unit 150.

The processor 111 or the central processing unit 150 may be configured to extract an instruction from the working memory 115 according to a preset sequence, analyze and process the instruction, and store the result of the process. In an embodiment, the processor 111 or the central processing unit 150 may be configured to receive a data object from the host device, process the data object, and transmit the processed data object to the nonvolatile memory device 120, or be configured to perform inverse processes thereof. The processor 111 or the central processing unit 150 may be configured to transmit various control information required for the processes to the working memory 115, the host interface 117 and the memory interface 119. In an embodiment, the processor 111 or the central processing unit 150 may operate according to firmware provided for various operations of the data storage device 10. In an embodiment, the processor 111 or the central processing unit 150 may implement a flash translation layer (FTL) to perform a garbage collection operation, an address mapping operation, a wear leveling operation, and so forth for managing the nonvolatile memory device 120. The processor 111 or the central processing unit 150 may also perform a function of detecting and correcting an error of data read out from the nonvolatile memory device 120.

The cache 113 is configured to temporarily store a data object received from the host device or a data object read from the nonvolatile memory device 120. Because the cache 113 has a high data read/write speed, some information to be frequently used, e.g., information about a write-in time and a logical address of a data block, may be stored in the cache 113 to facilitate a read operation. The cache 113 may be an arbitrary non-transitory machine readable medium capable of storing data such as a RAM, a storage-class memory (SCM), a non-volatile memory (NVM), a flash memory, or a solid state disk (SSD), but the cache 113 may be not limited thereto.

The working memory 115 may store program codes, e.g., firmware or software, required for the operation of the controller 110, and store code data and so forth to be used by the program codes. The program codes may include a computer operation instruction.

It will be understood that the working memory 115 may be a non-transitory machine readable medium, such as a RAM, a storage-class memory (SCM), a non-volatile memory (NVM), a flash memory or a solid state disk (SSD), capable of storing a program code.

The cache 113 and the working memory 115 may be integrated with each other or disposed separately from each other, and are not limited by the present embodiment of the present disclosure.

The host interface 117 may provide a communication channel for receiving a command and a clock signal from the host device (host processor) and controlling input/output of data under control of the central processing unit 150. In particular, the host interface 117 may provide physical connection between the host device and the data storage device 10. The host interface 117 may provide an interface with the data storage device 10 in correspondence with a bus format of the host device. The bus format of the host device may include at least one of standard interface protocols such as a secure digital, an universal serial bus (USB), a multi-media card (MMC), an embedded MMC (eMMC), a personal computer memory card international association (PCMCIA), a parallel advanced technology attachment (PATA), a serial advanced technology attachment (SATA), a small computer system interface (SCSI), a serial attached SCSI (SAS), a peripheral component interconnection (PCI), a PCI express (PCI-E), and an universal flash storage (UFS).

The memory interface 119 may provide a communication channel to transmit and receive signals between the controller 110 and the nonvolatile memory device 120. The memory interface 119 may write data temporarily stored in the cache 113 to the nonvolatile memory device 120 under control of the processor 111 or the central processing unit 150. The memory interface 119 may transmit data read out from the nonvolatile memory device 120 to the cache 113 to temporarily store the data to the cache 113.

The LVD processor 20 may monitor whether a supply voltage is falls below an allowable voltage level, that is, whether a low-voltage detection event occurs, during an operation of the data storage device 10, or in other words, while the processor 111 or the central processing unit 150 performs a process.

When the low-voltage detection event occurs, the LVD processor 20 may store a storage location of the process to return after a reset, that is, information about an instruction including an address of the instruction to return after the reset, in a preset storage space.

To this end, the processor 111 or the central processing unit 150 may treat the low-voltage detection event as an interrupt. When the low-voltage detection event occurs, the LVD processor 20 may store, in a certain storage space (e.g., a data retention space of the processor 111 or the central processing unit 150), information about an instruction that is being stored, and thereafter, request a reset. Then, the processor 111 or the central processing unit 150 may reset (i.e., initialize) the data storage device 10. During a reset operation, data (i.e., the information about an instruction that is being stored at the time of reset) of the data retention space may be retained without being lost. Thereafter, the information about the instruction stored in the data retention space may be transmitted to a debugging device and be used to debug the data storage device 10.

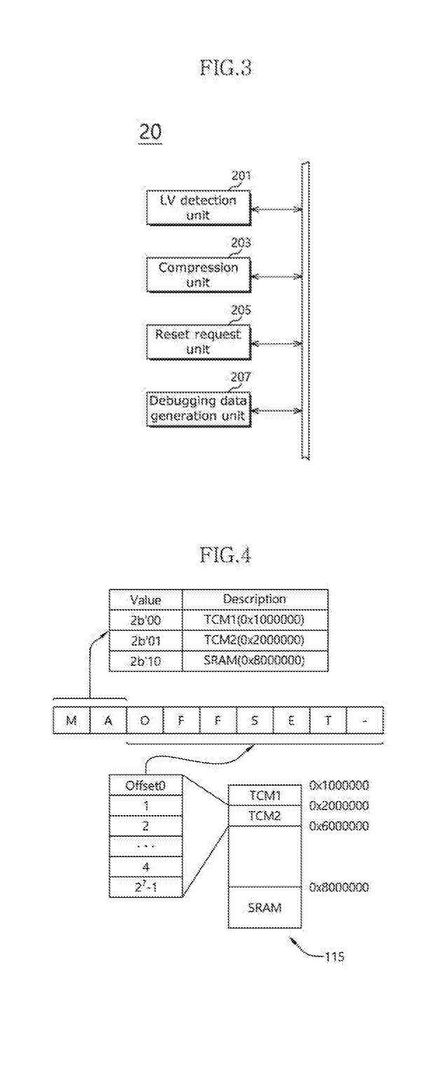

FIG. 2 is a configuration diagram illustrating the central processing unit 150 of FIG. 1 in accordance with an embodiment.

Referring to FIG. 2, the central processing unit 150 in accordance with the embodiment may include the processor 111 and the LVD processor 20. In an embodiment, the central processing unit 150 may be the processor 111 itself.

The processor 111 may include a decoder 1111, a control unit 1113, an arithmetic logic unit 1115, and a register 1117.

The decoder 1111 may be configured to analyze an instruction provided from the working memory 115 in which program codes have been written.

The control unit 1113 may be configured to generate a control signal by converting the instruction analyzed by the decoder 1111 into the control signal corresponding thereto. In an embodiment, the LVD processor 20 may be configured as a part of the control unit 1113, or form a control logic 1120 along with the control unit 1113. The control logic 1120 may perform substantially the same or similar functions performed by the control unit 1113.

The arithmetic logic unit 1115 may be configured to perform an arithmetic/logic operation in response to the control signal provided from the control unit 1113 or the control logic 1120.

The register 1117 may be a space for storing addresses, data, etc. to be used during an operation of the processor 111. The register 1117 may be classified into a general-purpose register GR, a state register SR, a link register LR, and a program counter PC depending on the purpose of use.

The general-purpose register GR may be used for data operations.

The state register SR may store the state of a process that is being operated, the state of the process in a previous operation mode, etc.

The link register LR may assign an address of an instruction, to which the processor 111 returns from a subroutine, or store an address of an instruction, to which the processor 111 returns after an interrupt is processed.

The program counter PC may store an address of an instruction that is being performed by the processor 111, that is, a location of the instruction to be read from a memory. When an interrupt occurs, the address of the program counter PC is moved to the link register LR, and after the interrupt has been processed, the address stored in the link register LR is moved to the program counter PC. Thereafter, an instruction corresponding to the address is processed, thus making it possible for the processor 111 to return to a process that has been performed before the interrupt occurs.

The LVD processor 20 may monitor whether a low-voltage detection event occurs during the operation of the data storage device 10. When the low-voltage detection event occurs, the LVD processor 20 may report the occurrence of the low-voltage detection event to the control unit 1113. The control unit 1113 may treat the low-voltage detection event as an interrupt, and store into the link register LR an address for the processor 111 to return after the interrupt is processed. In other words, the control unit 1113 may move and store the address of the program counter PC to the link register LR. Furthermore, after the data storage device 10 is reset as a result of occurrence of the low-voltage detection event, the control unit 1113 may move the address of the link register LR to the program counter PC so that the processor 111 returns to a process that has been performed before the low-voltage detection event occurs, thus making it possible to perform an instruction corresponding to the return address in a memory space.

The LVD processor 20 may detect the return address from the link register LR, and generate a compressed return address by compressing the return address into preset-bit data. Thereafter, the LVD processor 20 may store the compressed return address to a certain storage space of the register 1117, that is, a data retention space in which data is retained without being lost even after initialization. As a result, when the low-voltage detection event occurs, an address of an instruction that is being performed by the processor 111 is remembered as information about a return instruction in the data retention space, and after the data storage device 10 is reset, the processor 111 may return again to the time of the interruption of the process, based on the information about the return instruction.

FIG. 3 is a configuration diagram illustrating the LVD processor 20 of FIG. 1 in accordance with an embodiment.

Referring to FIG. 3, the LVD processor 20 may include a LV detection unit 201, a compression unit 203, a reset request unit 205, and a debugging data generation unit 207.

The LV detection unit 201 may monitor whether a supply voltage falls below a preset allowable voltage level during the operation of the data storage device 10. When a low-voltage detection event occurs by a reduction of the supply voltage below the preset allowable voltage level, the LV detection unit 201 may report it to the control unit 1113. Consequently, the control unit 1113 may treat the low-voltage detection event as an interrupt, and store into the link register LR an address for the processor 111 to return after the interrupt is processed. In other words, the address of the program counter PC may be moved and stored to the link register LR.

The compression unit 203 may extract a return address from the link register LR and generate a compressed return address, which is the extracted return address compressed into preset-bit data.

The reset request unit 205 and the debugging data generation unit 207 will be described in more detail below.

FIGS. 4 and 5 are diagrams illustrating a method of compressing an address in accordance with embodiments.

Referring to FIG. 4, the working memory 115 may include at least one memory area TCM1, TCM2, and SRAM in which program codes are stored. Each memory area TCM1, TCM2, SRAM may have a start address and an identifier (denoted as “Value” in FIG. 4) corresponding to the start address. A storage location of an instruction written in each memory area TCM1, TCM2, SRAM may be managed with an offset from the start address.

The compression unit 203 may determine an identifier (denoted as “M” and “A” corresponding to a value of the field “Value” in FIG. 4) of a memory area (e.g., TCM2 corresponding to a value “2b′01” in the field “Value” in FIG. 4) in which a return address extracted from the link register LR is stored among the areas of the working memory 115, and an offset (denoted as “1” to “2⁷−1” from the start address “Offset0” in FIG. 4) indicating a location at which the return address is stored in the corresponding memory area (e.g., TCM2), and generate a compressed return address using the identifier and the offset.

In other words, the compression unit 203 may generate instruction-related information including the compressed return address including information about the identifier of the memory area in which the return address is included and the offset in the corresponding memory area.

In an embodiment, the compression unit 203 may be configured to perform a hashing algorithm.

Referring to FIG. 5, the hashing algorithm may refer to a compression method of generating a hash index having a fixed length by applying an input value to a hash function F(x).

Therefore, when each of addresses ADD1, ADD2, and ADD3 provided as an input value is hashed, a compressed address (denoted as “compressed ADD” in FIG. 5) having a preset length (i.e., a preset number of bits) may be obtained as a hash index. Furthermore, when the hash index is reverse-hashed, the original address ADD1, ADD2, ADD3 that is the input value may be obtained

Referring again to FIG. 3, as the compressed return address formed by compressing the address of the link register LR is stored to the data retention space, the reset request unit 205 of the LVD processor 20 may request a reset of the data storage device 10 to the control unit 1113. Consequently, the control unit 1113 may initialize the data storage device 10. In an embodiment, when a low-voltage detection event is reported and the data storage device 10 is reset, the control unit 1113 may store a low-voltage detection event occurrence count. Even when the data storage device 10 is reset by the occurrence of the low-voltage detection event, information stored in the data retention space, e.g., information about the return instruction including the compressed return address generated and stored when the low-voltage detection event occurs, may be retained without being lost.

After the data storage device 10 has been reset and rebooted, the debugging data generation unit 207 of the LVD processor 20 may decompress the compressed return address extracted from the data retention space, generate the decompressed return address as debugging data, and store the debugging data to a debugging data storage region. The debugging data storage region may be a preallocated region of the cache 113 or the working memory 115. The debugging data generation unit 207 may receive the low-voltage detection event occurrence count from the control unit 1113 after the data storage device 10 has been reset, and store the low-voltage detection event occurrence count along with the decompressed return address as the debugging data.

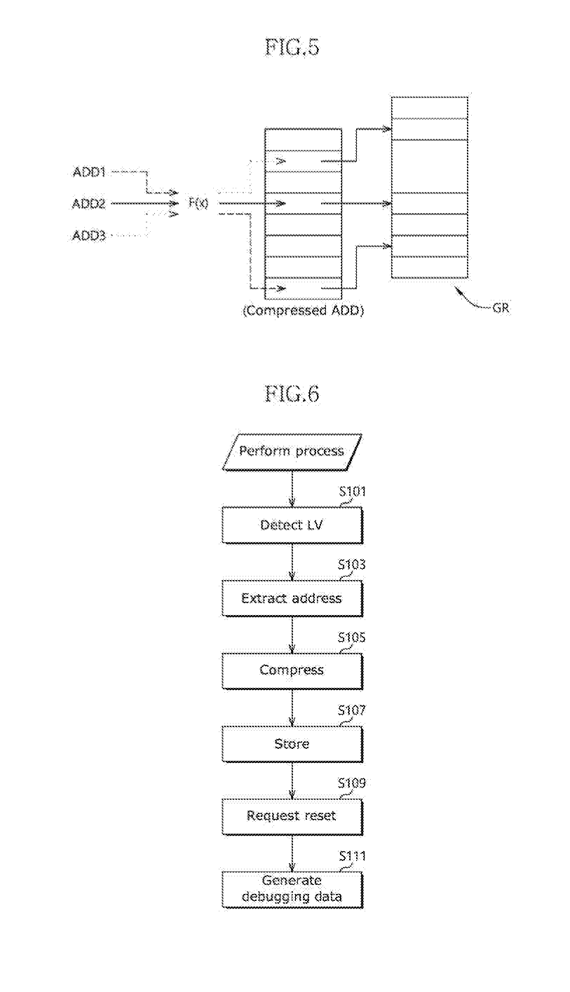

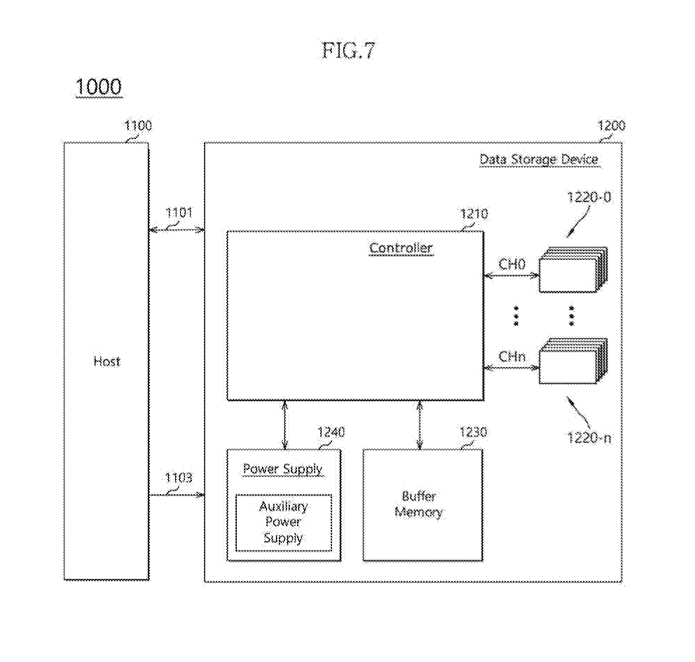

FIG. 6 is a flowchart illustrating a method of operating the data storage device 10 in accordance with an embodiment.

While a process is performed on the data storage device 10, the LVD processor 20 may monitor whether a supply voltage falls below the preset allowable voltage level at step S101.

When a low-voltage detection event occurs, the LVD processor 20 may report the occurrence of the low-voltage detection event to the control unit 1113.

Consequently, the control unit 1113 may store a return address through an operation of moving the address of the program counter PC to the link register LR. The LVD processor 20 may extract the return address from the link register LR at step S103, and compress the return address to generate a compressed return address having a preset number of bits at step S105. The compressed return address may be stored in the data retention space in which data is not lost even after a reset at step S107.

After the compressed return address has been reliably stored, the LVD processor 20 may request a reset to the control unit 1113 at step S109, whereby the data storage device 10 may be initialized. Even after the data storage device has been initialized, the compressed return address stored in the data retention space may be retained without being lost.

In an embodiment, when the control unit 1113 resets the data storage device 10 in response to the request of the LVD processor 20, the control unit 1113 may store a low-voltage detection event occurrence count.

After the data storage device 10 has been reset and rebooted, the LVD processor 20 may decompress the compressed return address extracted from the data retention space, generate the decompressed return address as debugging data, and store the debugging data to the debugging data storage region at step S111. The LVD processor 20 may receive the low-voltage detection event occurrence count from the control unit 1113 and store the low-voltage detection event occurrence count along with the decompressed return address as the debugging data.

The debugging data may be provided to a debugger. The debugger may determine which instruction of the data storage device 10 leads to the occurrence of the low-voltage detection event, thus making it possible to take appropriate measures accordingly.

FIG. 7 is a diagram illustrating a data processing system 1000 including a solid state drive (SSD) 1200 in accordance with an embodiment. Referring to FIG. 7, the data processing system 1000 may include a host device 1100 and the SSD 1200.

The SSD 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the SSD 1200. The controller 1210 may include a host interface unit, a control unit, a random access memory used as a working memory, an error correction code (ECC) unit, and a memory interface unit. In an embodiment, the controller 1210 may configured by controller 110 comprising the processor 111 or the central processing unit 150 including the LVD processor 20 as shown is FIG. 1 to FIG. 3.

The host device 1100 may exchange a signal with the SSD 1200 through the signal connector 1101. The signal may include a command, an address, data, and so forth. The host interface unit 1211 may interface the host device 1100 and the SSD 1200 according to the protocol of the host device 1100.

The controller 1210 may analyze and process the signal received from the host device 1100. The controller 1210 may control operations of internal function blocks according to a firmware or a software for driving the SSD 1200.

The ECC unit may detect an error of the data read from at least one of the nonvolatile memory devices 1220-0 to 1220-n. If a detected error is within a correctable range, the ECC unit may correct the detected error.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the SSD 1200. The nonvolatile memory devices 1220-0 to 1220-n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1103, to the inside of the SSD 1200. The power supply 1240 may include an auxiliary power supply. The auxiliary power supply may supply power to allow the SSD 1200 to be normally terminated when a sudden power-off occurs. The auxiliary power supply may include large capacity capacitors.

The signal connector 1101 may be configured by various types of connectors depending on an interface scheme between the host device 1100 and the SSD 1200.

The power connector 1103 may be configured by various types of connectors depending on a power supply scheme of the host device 1100.

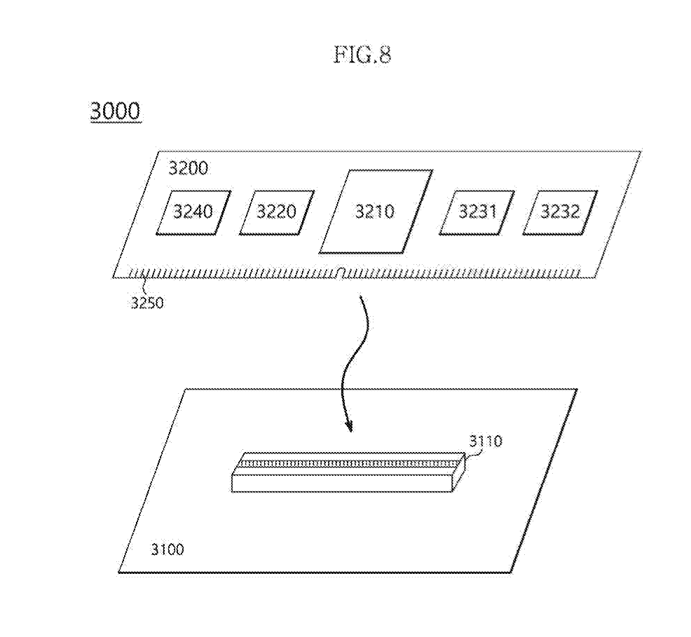

FIG. 8 is a diagram illustrating a data processing system 3000. Referring to FIG. 8, the data processing system 3000 may include a host device 3100 and the memory system 3200.

The host device 3100 may be configured in the form of a board such as a printed circuit board. Although not shown, the host device 3100 may include internal function blocks for performing the function of a host device.

The host device 3100 may include a connection terminal 3110 such as a socket, a slot or a connector. The memory system 3200 may be mounted to the connection terminal 3110.

The memory system 3200 may be configured in the form of a board such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 comprising the processor 111 or the central processing unit 150 including the LVD processor 20 as shown is FIG. 1 to FIG. 3.

The buffer memory device 3220 may temporarily store data to be stored in the nonvolatile memory devices 3231 and 3232. Further, the buffer memory device 3220 may temporarily store the data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250, to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data and so forth and power may be transferred between the host device 3100 and the memory system 3200. The connection terminal 3250 may be configured into various types depending on an interface scheme between the host device 3100 and the memory system 3200. The connection terminal 3250 may be disposed on any one side of the memory system 3200.

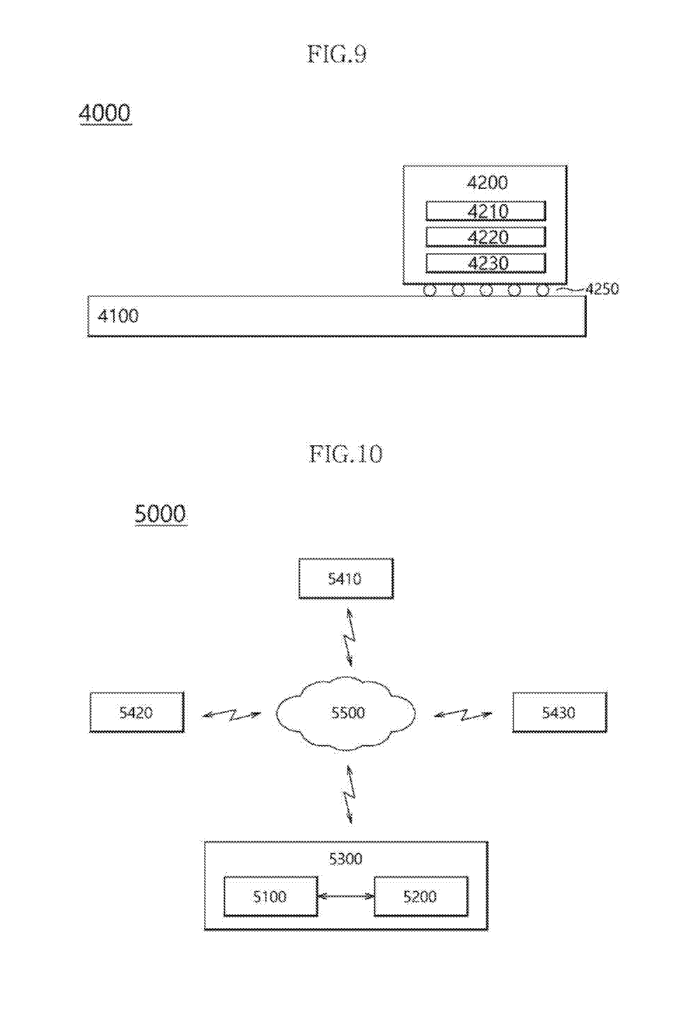

FIG. 9 is a diagram illustrating a data processing system 4000 including a memory system 4200 in accordance with an embodiment. Referring to FIG. 9, the data processing system 4000 may include a host device 4100 and the memory system 4200.

The host device 4100 may be configured in the form of a board such as a printed circuit board. Although not shown, the host device 4100 may include internal function blocks for performing the function of a host device.

The memory system 4200 may be configured in the form of a surface-mounting type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 comprising the processor 111 or the central processing unit 150 including the LVD processor 20 as shown is FIG. 1 to FIG. 3.

The buffer memory device 4220 may temporarily store data to be stored in the nonvolatile memory device 4230. Further, the buffer memory device 4220 may temporarily store the data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

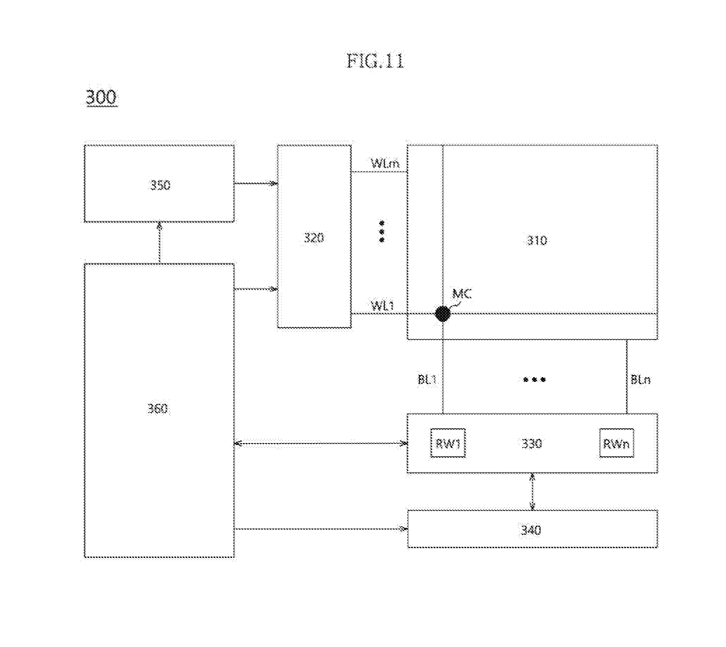

FIG. 10 is a diagram illustrating a network system 5000 including a memory system 5200 in accordance with an embodiment. Referring to FIG. 10, the network system 5000 may include a server system 5300 and a plurality of client systems 5410 to 5430 which are coupled through a network 5500.

The server system 5300 may service data in response to requests from the plurality of client systems 5410 to 5430. For example, the server system 5300 may store the data provided from the plurality of client systems 5410 to 5430. For another example, the server system 5300 may provide data to the plurality of client systems 5410 to 5430.

The server system 5300 may include a host device 5100 and the memory system 5200. The memory system 5200 may be configured by the memory system 10 shown in FIG. 1, the SSD 1200 shown in FIG. 7, the memory system 3200 shown in FIG. 8 or the memory system 4200 shown in FIG. 9.

FIG. 11 is a block diagram illustrating a nonvolatile memory device 300 included in a memory system in accordance with an embodiment. Referring to FIG. 11, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other. The memory cell array 310 may comprise a three-dimensional memory array. The three-dimensional memory array has a direction perpendicular to the flat surface of a semiconductor substrate. Moreover, the three-dimensional memory array means a structure including NAND strings which at least memory cell is located in a vertical upper portion of the other memory cell. However, the structure of the three-dimensional memory array is not limited thereto.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

While various embodiments have been described above, it will be understood to those skilled in the art that the embodiments described are examples only. Accordingly, the data storage device, the operating method thereof and the storage system including the same described herein should not be limited based on the described embodiments.

What is claimed is:

1. A data storage device comprising:
a nonvolatile memory device; and
a controller including a register, and suitable for extracting an instruction from a working memory according to a preset sequence to control the nonvolatile memory device, analyzing and processing the instruction, and storing a result of the processing, and suitable for storing, when a low-voltage detection event occurs, an address of an instruction that is being performed, to a preset data retention space as return instruction information, and then performing a reset operation.

2. The data storage device according to claim 1, wherein the data retention space is a space in which a prestored data is retained regardless of the reset operation.

3. The data storage device according to claim 1, wherein the data retention space is allocated as a part of the register.

4. The data storage device according to claim 1, wherein the controller is configured to compress and store the address of the instruction that is being performed.

5. The data storage device according to claim 1, wherein the controller is configured to generate the return instruction information as debugging data after the reset operation.

6. A data storage device comprising:
a nonvolatile memory device; and
a controller suitable for controlling data exchange for the nonvolatile memory device,
wherein the controller comprises:
a register;
a working memory in which a program code is stored;
a control unit suitable for extracting an instruction from the working memory according to a preset sequence, and processing the instruction; and
a low-voltage detection processor suitable for storing, when a low-voltage detection event occurs, an address of an instruction that is being performed, to a preset data retention space as return instruction information, and then requesting a reset to the control unit.

7. The data storage device according to claim 6, wherein the low-voltage detection processor comprises:
a low-voltage detection unit suitable for monitoring whether the low-voltage detection event occurs, and reporting the low-voltage detection event to the control unit; and
a compression unit suitable for compressing a return address and storing the compressed return address to the data retention space as the return instruction information when the control unit extracts, as the return address, the address of the instruction that is being performed in response to the low-voltage detection event.

8. The data storage device according to claim 7, wherein the low-voltage detection processor further comprises a debugging data generation unit suitable for generating the return instruction information as debugging data after a reset operation.

9. The data storage device according to claim 7, wherein the low-voltage detection processor further comprises a reset request unit suitable for requesting a reset to the control unit, as the compressed return address formed by compressing the return address is stored to the data retention space.

10. The data storage device according to claim 6, wherein the data retention space is at least a part of the register in which prestored data is retained regardless of a reset operation.

11. An operating method of a data storage device including a nonvolatile memory device and a controller suitable for controlling data exchange for the nonvolatile memory device, the method comprising:
monitoring, by the controller, whether a low-voltage detection event occurs;
extracting, by the controller, an address of an instruction that is being performed when the low-voltage detection event occurs;
storing, by the controller, the extracted address of the instruction to a preset data retention space as return instruction information; and
performing a reset operation by the controller.

12. The operating method according to claim 11, further comprising:
generating the return instruction information as debugging data after the reset operation.

13. The operating method according to claim 11, wherein the data retention space is at least a part of a register in which prestored data is retained regardless of the reset operation.

14. A storage system comprising:
a host device; and
a controller including a nonvolatile memory device, and suitable for extracting an instruction from an working memory according to a preset sequence so as to control the nonvolatile memory device, analyzing and processing the instruction, and storing a result of the processing, and suitable for storing, when a low-voltage detection event occurs, an address of an instruction that is being performed, to a preset data retention space as return instruction information, and then performing a reset operation.

15. The storage system according to claim 14, wherein the data retention space is a space in which prestored data is retained regardless of the reset operation.

16. The storage system according to claim 14, wherein the controller comprises a register, and the data retention space is allocated as a part of the register.

17. The storage system according to claim 14, wherein the controller is configured to compress and store the address of the instruction that is being performed.

18. The storage system according to claim 14, wherein the controller is configured to generate the return instruction information as debugging data after the reset operation.

19. A controller comprising:
a low-voltage detection (LVD) processor suitable for detecting a LVD event of a memory device; and
a control processor suitable for:
initializing the memory device according to the detection while retaining an information of an instruction being executed at a time of the detection; and
executing a series of instructions to control the memory device after the initialization by referring to the retained information.
